(19) United States
(12) Patent Application Publication
(10) Pub. No.: US 2015/0295759 A1
(43) Pub. Date: Oct. 15, 2015

(54) METHOD FOR CONFIGURING A COMMUNICATION DEVICE USING A CONFIGURATION FILE TEMPLATE

(71) Applicant: TELEFONAKTIEBOLAGET L M ERICSSON (PUBL), Stockholm (SE)

(72) Inventor: David Möllersten, Karlskrona (SE)

(21) Appl. No.: 14/439,099

(22) PCT Filed: Oct. 31, 2012
(86) PCT No.: PCT/SE2012/051187

§ 371 Date: Apr. 28, 2015

(51) Int. Cl. H04L 12/24; G06F 17/30

(52) U.S. Cl. CPC H04L 41/0806; G06F 17/30203; G06F 17/30221

(57) ABSTRACT

Methods and apparatuses create a configuration file for a communication device in a communications network to mitigate management of communication device models and their configuration files. A device configuration node responds to detecting a stimulus to configure the communication device by: determining a communication device identity based on the stimulus; retrieving based on the communication device identity a configuration file template having a data variable; retrieving based on the communication device identity a data value corresponding to the data variable of the configuration file template; assigning the data value to the corresponding data variable of the configuration file template; and consolidating the configuration file template into a configuration file. Retrieval of the data value includes traversing a hierarchical data structure of a plurality of data variables, and the data value is selected in accordance with an assignment rule.

### TECHNICAL FIELD

The present invention relates to device management and more particularly to a method and device configuration node for creation of a configuration file for a communication device in a communication network.

### BACKGROUND

To achieve traffic growth in communications networks it is important that applications are made available to the full extent that devices intended to use these applications support them.

Operators of communication services use automatic device management to manage mobile, for example mobile phones and laptops, as well as fixed access devices such as cable modems and set top boxes. This brings increased use of data services such as Internet access, E-mail and Internet Protocol television (IPTV).

Further, automatic device management makes it possible for operators to take instant action with information about device detection received from the network. This involves selecting all services that are subscribed to and can be supported by the device. The correct configuration details are then automatically provided to the device, for example a mobile phone over-the-air.

The area of automatic device management includes all operations that are necessary in order to manage a device. This enables automatic provisioning of network access point settings, such as E-mail and Internet settings. It also includes delivery of applications and firmware.

Advantages for the operator in using automatic device management includes for example reducing the number and duration of customer care calls, cutting operational expenditure, improving the quality of service delivery based on real-time device usage information. A major advantage is service uptake, i.e. that the users are in fact using the services that are available to them.

For the service provider, automatic device management means reduced costs for installation, service provisioning, maintenance, trouble shooting and customer care, because it largely eliminates the need for human involvement in these processes.

For the user of the device, for example a correctly configured handset or cable modem, users can take full advantage of the rich offering of services, such as internet surfing for information and enjoying media content, or taking advantage of community and messaging services.

A well known method of configuring a device utilizes a configuration file containing configuration settings.

One configuration file based solution is disclosed by U.S. Pat. No. 7,409,709 wherein systems and methods are disclosed for automatically configuring, managing, and maintaining a network device or Virtual Private Network (VPN) using a public network such as the Internet. Initial configuration of a network device or VPN occurs upon the user entering information via an

Hypertext Markup Language (HTML) page. After receipt of this information, the network device or VPN is automatically configured without user intervention. The network configuration process includes transmitting the user data from the portal to a management device; creating a configuration file at the management device; automatically establishing a communication between the management device and the network device via a network connection of a network; transmitting the configuration file from the management device to the network device via the network connection and automatically reconfiguring the network device via local processing of the configuration file.

A problem with configuring a device by transferring a configuration file is that the file needs to be stored and managed for all models and types of devices that need to be managed.

As an example of the magnitude of device models and types, cable modems alone may sum up to thousands of variants counting various models from all vendors. This number is constantly growing as new device models are regularly introduced. A device model database may include basic information such as brand, model and type codes, as well as a number of device capabilities and attributes. Managing such an amount of device models and their associated configuration files constitutes a monumental task for the operator administering the devices. Yet, today there exist numerous legacy devices in the market that can only be configured by uploading a configuration file to them. The problem with numerous static configuration files can be relieved to some extent by interchangeable configuration sets containing parameters referenced in the configuration file. All variables in the configuration file are then exchanged in accordance with the parameter set before the configuration file is uploaded to the device. However, if there is a need to further differentiate the settings based on attributes like type of device, where it is located, who it belongs to, etc—then the number of configuration sets increases at an alarming rate.

### SUMMARY

An object of the invention is to provide a method and apparatus for creation of a configuration file for a communication device in a communications network mitigating the problem of managing communication device models and their associated configuration files.

One aspect of the invention relates to a method for creation of a configuration file for a communication device in a communications network comprising a device configuration node which in response to detecting a stimulus to configure the communication device is performing the steps of determining a communication device identity based on the stimulus; retrieving based on the communication device identity a configuration file template comprising a data variable; retrieving based on the communication device identity a data value corresponding to the data variable of the configuration file template; assigning the retrieved data value to the corresponding data variable of the configuration file template; consolidating the configuration file template into a configuration file; wherein the step of retrieving the data value comprises traversing a hierarchical data structure comprising a plurality of data variables and wherein the data value is selected in accordance with an assignment rule.

It is an advantage of the invention that it reduces the time/cost necessary to manage a large population of devices with a need for differentiated settings and where configuration needs to be uploaded to the devices using configuration files because the rules can be expressed more condensed compared to prior art approaches.

It is another advantage that the invention makes it possible to create very expressive rules based on assignment rules such as for example inheritance also for devices that use a relatively primitive settings delivery mechanism of uploading configuration files to the device.

Another aspect of the invention relates to a device configuration node for creation of a configuration file for a communication device in a communications network comprising a processor and a memory storing instructions that when executed by the processor cause the device configuration node to, in response to detecting a stimulus to configure the communication device: determining a communication device identity based on the stimulus; retrieving, based on the communication device identity, a configuration file template comprising a data variable; retrieving, based on the communication device identity, a data value corresponding to the data variable of the configuration file template; assigning the retrieved data value to the corresponding data variable of the configuration file template with the corresponding data value; consolidating the configuration file template into a configuration file; wherein retrieving the data value comprises traversing a hierarchical data structure comprising a plurality of data variables wherein the data value is selected in accordance with an assignment rule.

Embodiments of the invention will now be described in more detail with reference to the enclosed drawings.

### BRIEF DESCRIPTION OF THE DRAWINGS

FIG. 1 is a block diagram showing the architecture for a device management system.

FIG. 2 is a flow chart showing a method for creation of a configuration file and configuration of a communication device according to an exemplary embodiment of the invention.

FIG. 3 is a schematic diagram showing the retrieval of configuration file templates and data values in a method for creation of a configuration file and configuration of a communication device according to an exemplary embodiment of the invention.

FIG. 4a is a block diagram showing an exemplary device management system in the form of a computing system environment having a device configuration node for creation of a configuration file and configuration of a communication device including a device configuration unit

FIG. 4b is a block diagram showing a device configuration unit according to an exemplary embodiment of the invention.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

The area of device management concerns delivery of access and service settings, client applications as well as firmware upgrades to capable terminals. Some types of devices, in particular various cable modems and broadband modems, are capable of receiving device management actions based on a received configuration file as their only device management mechanism.

It has been has discovered that by using configuration files containing data variables and retrieving values to assign to these variables based on an hierarchical data structure makes it possible to manage for example for legacy devices in an efficient manner by decreasing the number of configuration files or configuration file templates. The values are assigned to the data variables based on an assignment rule for example and inheritance function and makes it possible to achieve a wide differentiation of configuration settings in a large device population. Embodiments described herein allows for constructing a system where devices using configuration files can be managed in a similar way as devices using more sophisticated, e.g. two way, communication protocols. This in turn makes it possible to create a converged management solution targeting both legacy configuration file based devices and newer protocol based solutions.

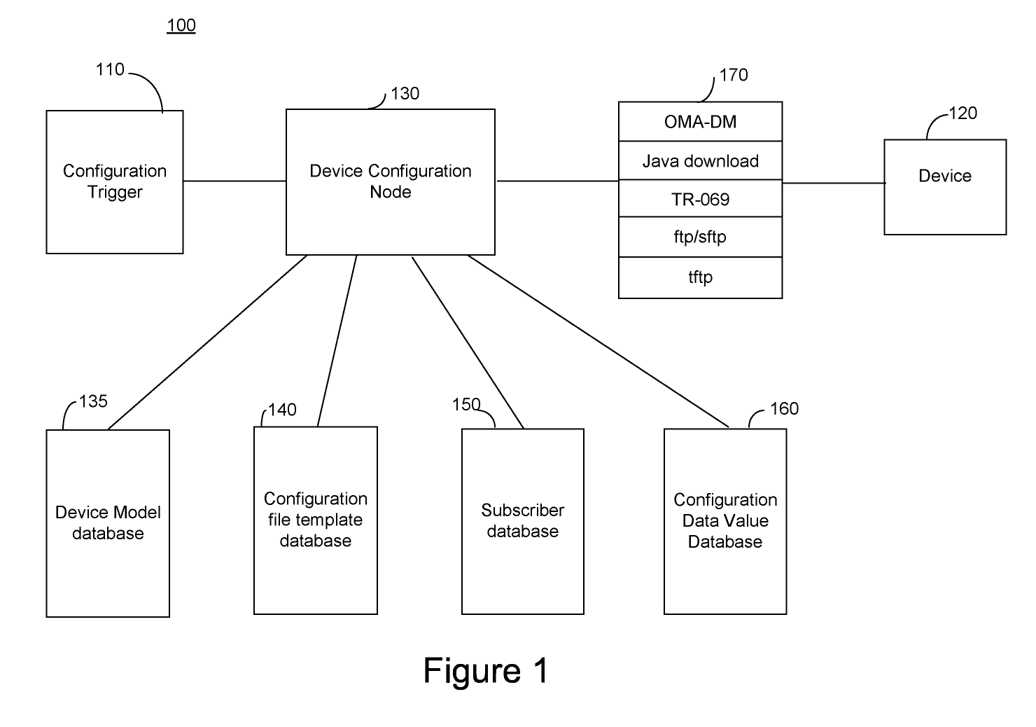

FIG. 1 is a block diagram showing the architecture for a device management system.

A Configuration Trigger (CT) 110 provides stimuli for configuring a device (120) in a communication network 100, with support for uploading configuration files, to a Device Configuration Node (DCN) 130. In some embodiments the DCN is a computer running Unix or Linux operating systems. Devices may include for example mobile terminal such as Global System for Mobile communications (GSM), Universal Mobile Telecommunications System (UMTS), broadband/Asymmetric Digital Subscriber Line (ADSL) modems, cable modem, machine-to-machine (M2M) devices, residential gateways and set-top boxes for TV solutions used by cable, satellite and terrestrial operators etc. The device may also be a Subscriber Identity Module (SIM) card. The CT may be the device (120) requesting a new configuration using file transfer protocol (ftp), secure ftp (sftp) or trivial FTP (tftp). In a mobile network the CT can be a Home Location Register (HLR), an Equipment Identity Register (EIR). The CT may be an automatic real-time detection system detecting for example new terminal and SIM card combinations in a mobile network. Examples are new IMEI, MSISDN and IMSI combinations. The CT may also be a terminal console operated by a human operator or a north bound system like a Business Support System (BSS) or Operations Support System (OSS). Further, file based triggers can be used to enter information in the DCN either as a stand alone trigger, e.g. Call Detail Record (CDR) based trigger, or in combination with other triggers to complement information retrieved from the network. Another CT type is probe based detection wherein listening probes in the communication network are used. In a mobile network, such probes may be located in front of the EIR to intercept and register new combinations of IMEI, MSISDN and IMSI. The CT may also constitute an internal trigger according to a configured rule of the device management system triggered by any possible external or internal stimuli. In addition to the device identity the trigger generated by the CT towards the DCN may also comprise an arbitrary list of additional identities related to groups of which the device is a member.

The DCN 130 is arranged to detect the stimulus from the CT to configure the communication device. The DCN determines a device identity based on the stimulus. This can be done by retrieving the identity from the stimulus, e.g. request message itself (e.g. based on parameters conveyed in a request message). It can also be determined by using data conveyed in the request to look up the required identity from a (subscriber) data base. The device identity can be a subscriber MSISDN (+46 733 123 321), an IMEI, social security number (730411-1234), an IP address, a computer media access control (MAC) address, etc

Based on the device identity the DCN accesses a Device Model Database (DMDB) 135 to look up device model of the device. Each device model may indicate one or several configuration file templates each identifying data variables needed to be set in the device for the respective service. A Configuration File template Database (CFTDB) 140 is subsequently accessed for retrieving the identified one or plural configuration file templates. A configuration file template is for example a computer file such as a plain text file, a binary file, an executable file, a script file, or any other format intended to constitute a component of a configuration file ultimately sent to the device. The configuration file template holds data variables such as GPRS settings, WAP settings, MMS settings, IPTV server settings or any other type of settings intended for device management. A configuration file template may be applicable for one or several device models.

The DCN retrieves all configuration file templates that are applicable to the device in the current situation.

In addition the DCN may further determine an arbitrary list of additional group identities related to groups of which the device or subscriber is a member. The device identity—e.g. IMSI/IMEI/MAC address or subscriber identity—e.g. MSIDN or IP address, is used to lookup group identities from Subscriber Database (SDB) 150. The SDB provides for deduce device identity from subscriber identity and vice versa.

The DCN also retrieves, based on the device identity, one or plural data values corresponding to the data variables of the configuration file template from a Configuration Data Value Database CDVDB 160. The data variable and data values that are applicable to the device may depend on device model, type of contact (first device contact, periodic device contact etc.), or any device characteristic and/or any type of stimuli. The DCN assigns the data variables of the configuration file template(s) with the corresponding data values. Retrieval of data values can be performed independently, e.g. in parallel, with the retrieval of the configuration file templates, wherein only those values relevant for the retrieved configuration file templates needs to be used.

A configuration file template may also hold default values. That is, data values for data variables that are used for the configuration if no data value is obtained from the CDVDB.

The retrieval of data values may be done by traversing a hierarchical data structure of the CDVDB having data values wherein the data value is selected in accordance with an assignment rule. The assignment rule may be an inheritance settings function where the data values are organized in a data structure with nodes of the data structure holding data values. The data value is then assigned in accordance with a rule wherein the value of the lowest level node applicable for the device is used. Individual values may be retrieved by lookup towards external sources if the assignment rule so specify. The data structure may be a tree structure but also a weave or other types of directed graph data structures allowing the determination of whether a higher ranked data value overrides a lower ranked value. Such higher or lower ranking can be expressed in a data structure with direction between data values so that for example an earlier value is overridden by a value further down the data structure. The opposite is also possible, i.e. that an earlier value overrides a lower ranked later value in the structure. As an example, a subordinate set of data values may override the values of corresponding data variables in its super set.

The DCN is then arranged to consolidate the configuration file template(s) that has been assigned values into a configuration file and transmitting the configuration file over a configuration uploading interface 170 to the device. Several protocols may be used for the configuration uploading interface, wherein examples are Open Mobile Alliance (OMA) Device Management (DM) (OMA-DM), java download, TR-069 (specified by the Broadband Forum), ftp, sftp or tftp.

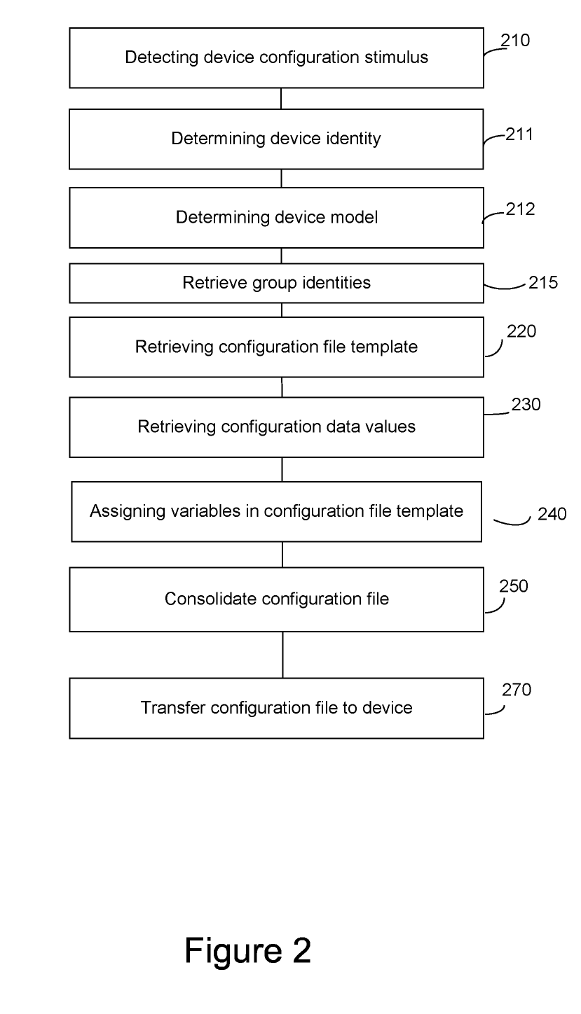

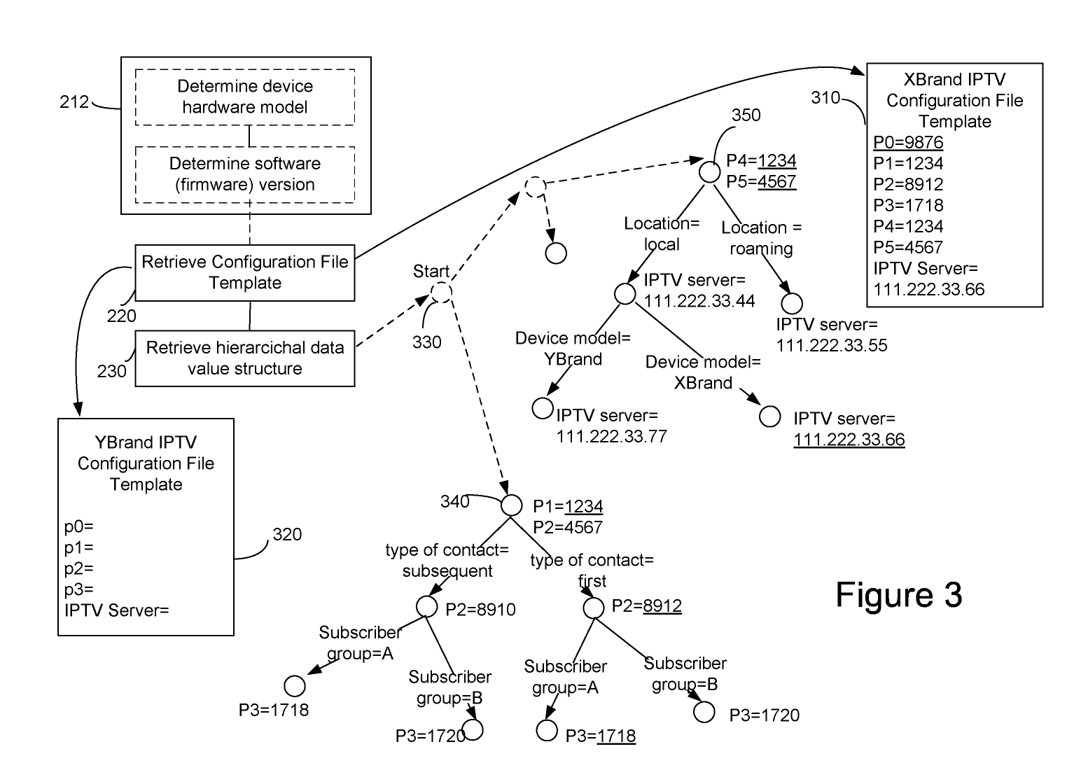

The method for configuration of a communication device according to an exemplary embodiment of the invention will now be described with reference to FIG. 2 and FIG. 3.

FIG. 2 is a flow chart showing a method for creation of a configuration file and configuration of a communication device while FIG. 3 is a schematic diagram showing the retrieval of configuration file templates and data values in the method according to an exemplary embodiment of the invention.

The device configuration node 130 detects in step 210 a stimulus, for example the first contact towards the network by a device, triggering configuration of the device. The type of stimulus may be any of a request received via a man-machine interface, a business support system or a network event trigger.

The DCN continues in step 211 with determining the device identity, for example the MAC address 01-23-45-67-89-ab, based on the stimulus.

Using the device identity a device model is obtained in step 212. In the example of FIG. 3 the DMDB is inquired to obtain the device model, in this case a set top box XBrand. For hardware models where different software versions may exist, for example different firmware versions for the same hardware, the software version is also determined in step 212. The software version may be provisioned in the DMDB for the identified device identity or model. The software version may also be retrieved by inquiring the device using a protocol such as TR-069. A device model may be defined by its hardware model, software version or the combination therefore. Thus, when the software version of a device is updated a new configuration file template may be identified such that a new configuration file may be provided to the device.

Identities relating to a group of which the device, user or subscriber is a member may be obtained in step 215.

In step 220 the DCN is retrieving an applicable configuration file template from the CFTDB for the device using the obtained device model, i.e. hardware model, software model or a combination thereof—having been identified based on the device identity.

In the example of FIG. 3 a configuration file template 310 for the YBrand IPTV set top box is obtained. For reason of illustration another configuration file template 320 for another IPTV set top box YBrand is also shown. For example, the configuration file template for XBrand may be an Extensive markup Language (XML) file while the configuration file template for YBrand may be a semicolon separated configuration file template.

The configuration file templates comprise one or several data variables enabling the storage of data values. In this example data values for data variables P0, P1, P2, P3 and IPTV Server is required for the YBrand configuration file template 310 while a data value for the data variables P0-P5 and IPTV Server is required for the XBrand configuration file template 320. In this example p0 is a data value set by default to 9876 in the configuration file template.

In step 230 the DCN is in retrieving data values from the CDVDB corresponding to the data variable of the configuration file template. The retrieving is based on the device identity in that for example the device identity is used for the look up, or that the retrieved device model are used to look up the data values. Alternatively, the retrieving is based on the device identity in that the data values are looked up based on data variables of the retrieved configuration file template.

In step 240 data variables of the configuration file template are assigned with data values. The data values are stored in a hierarchical data structure, e.g. a tree structure, comprising a plurality of data variables. By traversing the hierarchical data structure data value are selected in accordance with an assignment rule. In the example shown in FIG. 3 the hierarchical structure is a weave structure but may also be for example a tree structures. The assignment rule adheres here to an inheritance based style of rule. In the weave based example the weave has a start point 330. The weave is traversed and routes in the weave are selected based on testing their associated conditions. In the weave of FIG. 3, once the node 340 for data variable P1 is reached the data value is set to P1=1234 as no lower level instance of P1 exists. Data variable P2 exists also on a lower level in the tree. As in this example the set top box is performing a first contact with the network, that branch of the weave is selected and P2=8912 is set since no lower level value exists in the weave. Default data values set in the configuration file template may be overridden by values set in the CDVDB, in this example however, data value P0=9876 is not overridden.

If group identities where obtained in step 215 the retrieving of data values in step 230 may be done also based on these additional identities. In this case, the subscriber is a member of group A such that P3=1718 is selected.

The data values of the XBrand configuration file template will therefore be assigned with P1=1234, P2=8912 and P3=1718 in step 240. In the same manner the path from the start point 330 to the node 350 is traversed upon its respective conditions being fulfilled. Data variables P4 and P5 exists only in node 350 and data values are therefore selected as P4=1234 and P5=4567. The IPTV server address is however selected first after that it has been determined that the set top box is located in the local network and is of the model XBrand, thereby assigning the IPTV server=111.222.33.66 overriding the higher level values. Data values or group identities may also be retrieved by lookup towards an external source.

The data values of the IPTV configuration file template may thus be assigned with P0=9876, P1=1234, P2=8912, P3=1718, P4=1234, P5=4567 and IPTV Server=111.222.33.66 in step 240.

The configuration file template, or if plural configuration file templates are applicable, is subsequently consolidated into a configuration file by the DCN in step 250. In the common case the consolidation is done by creating one configuration file based on each configuration file template, but e.g. concatenating several templates into one file is also possible. The DCN may iterate over several applicable configuration file templates and exchanges all variables in these based on the compiled data settings. As an alternative, the configuration file templates may first be consolidated into one or plural files and thereafter assigned with data values in accordance with step 240.

In step 270 the configuration file is transmitted to the device. This transmission may include transmitting to a subscriber identity module (SIM) of the device, e.g. a soft-SIM, SIM, micro-SIM etc. The method for configuration of the communication device may iterate over a plurality of configuration files and constituent configurations file templates applicable for different services. For example, the configurations for the above exemplified VoIP and IPTV capabilities may be instantiated and transmitted in the form of two separate configuration files.

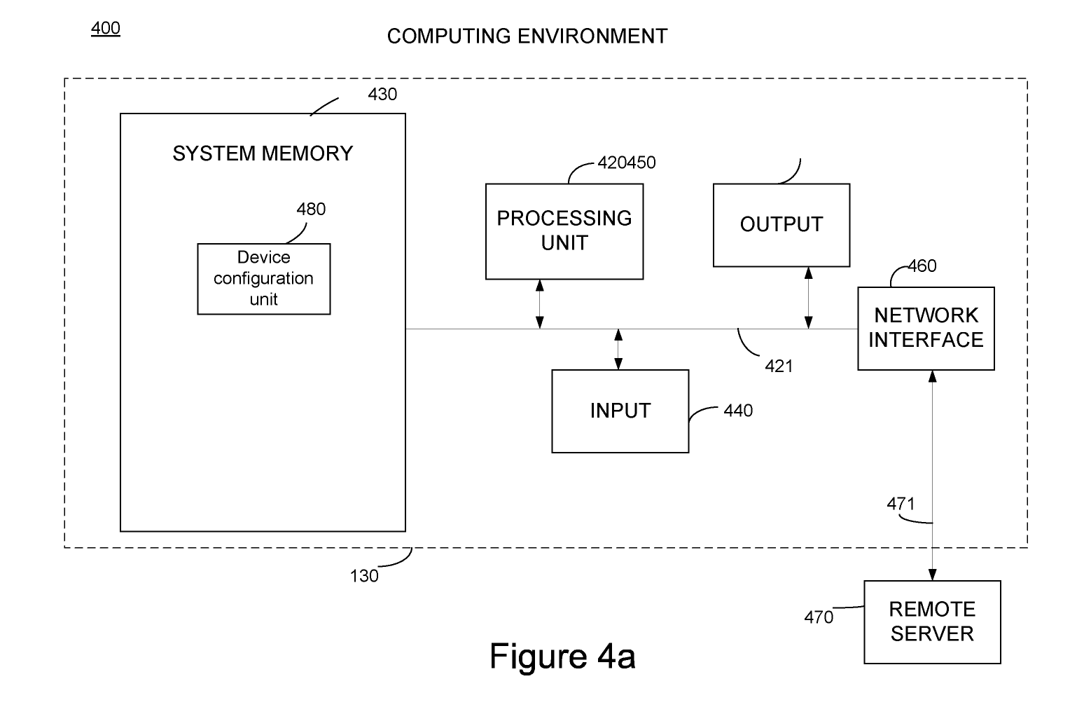

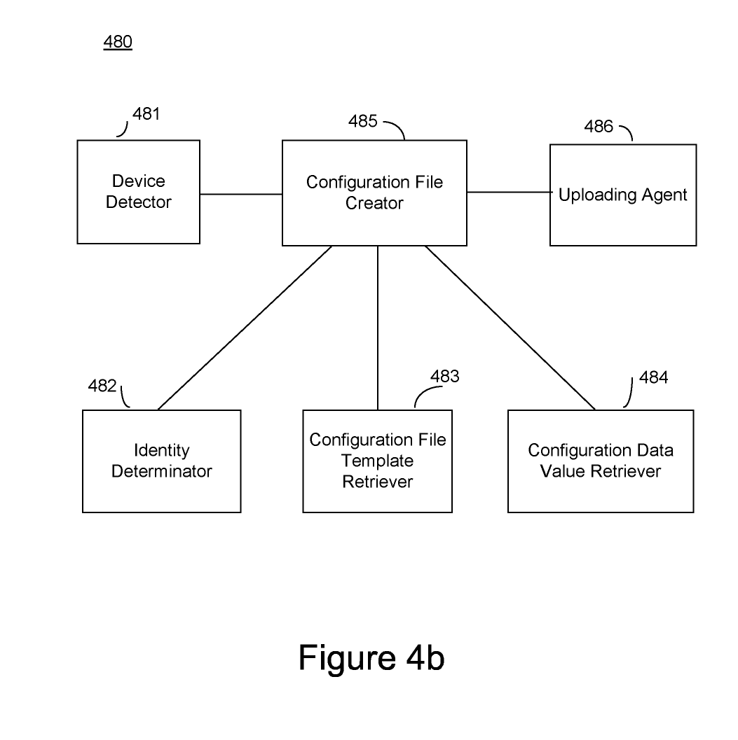

FIG. 4a is a block diagram showing an exemplary device management system in the form of a computing system environment 400 having a device configuration node 130 for creation of a configuration file and configuration of a communication device including a device configuration unit (DCU) 480. FIG. 4b is a block diagram showing the DCU according to an exemplary embodiment of the invention.

Although as made clear above, the computing system environment 400 is only one example of a suitable computing environment for a device management system and is not intended to suggest any limitation as to the scope of use or functionality of the claimed subject matter. Further, the computing environment 400 is not intended to suggest any dependency or requirement relating to the claimed subject matter and any one or combination of components illustrated in the example operating environment 400.

An example of a device for implementing the previously described DCN 130 includes a general purpose computing device in the form of a computer. Components of the computer can include, but are not limited to, a processing unit 420, a system memory 430, and a system bus 421 that couples various system components including the system memory to the processing unit 420. The system bus 421 can be any of several types of bus structures including a memory bus or memory controller, a peripheral bus, and a local bus using any of a variety of bus architectures.

The computer can include a variety of computer readable media. Computer readable media can be any available media that can be accessed by computer. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the computer. Communication media can embody computer readable instructions, data structures, program modules or other data in a modulated data signal such as a carrier wave or other transport mechanism and can include any suitable information delivery media.

The system memory 430 can include computer storage media in the form of volatile and/or nonvolatile memory such as read only memory (ROM) and/or random access memory (RAM). A basic input/output system (BIOS), containing the basic routines that help to transfer information between elements within computer, such as during start-up, can be stored in memory 430. Memory 430 can also contain data and/or program modules that are immediately accessible to and/or presently being operated on by processing unit 420. By way of non-limiting example, memory 430 can also include an operating system, application programs, other program modules, and program data.

In one embodiment the DCU is a software module loaded in the system memory and processable by the processing unit. The DCU comprises the further software modules Device Detector 481, Identity Determinator 482, Configuration File template Retriever 483, configuration Value Retriver, Configuration File Creator 485 and an Uploading Agent 486.

The DCU is adapting the DCN, thereby causing the device configuration node to, in response to the Device Detector detecting a stimulus to configure the communication device, determine, by the Identity Determinator, a communication device identity based on the stimulus. The Configuration File template Retriever further causes the retrieving of a configuration file template comprising a data variable, based on the device identity. The Configuration Value Retriever causes the DCU to retrieve, based on the device identity, a data value corresponding to the data variable of the configuration file template by traversing a hierarchical data structure comprising a plurality of data variables wherein the data value is selected in accordance with an assignment rule. The DCU further causes the device configuration node to assign the data variable of the configuration file templates with the corresponding data value. The Configuration File Creator causes the DCU to consolidate the configuration file template into a configuration file. The Uploading Agent causes the DCU to transmit the configuration file to the device.

The computer can also include other removable/non-removable and volatile/nonvolatile computer storage media. For example, computer can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 421 through a non-removable memory interface such as an interface, and a magnetic disk drive or optical disk drive can be connected to the system bus 421 by a removable memory interface, such as an interface.

A user can enter commands and information into the computer through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 420 through user input 440 and associated interface(s) that are coupled to the system bus 421, but can be connected by other interface and bus structures, such as a parallel port, game port or a universal serial bus (USB).

A graphics subsystem can also be connected to the system bus 421. In addition, a monitor or other type of display device can be connected to the system bus 421 through an interface, such as output interface 450, which can in turn communicate with video memory. In addition to a monitor, computers can also include other peripheral output devices, such as speakers and/or printing devices, which can also be connected through output interface 450.

The computer can operate in a networked or distributed environment using logical connections to one or more other remote computers, such as remote server 470, which can in turn have media capabilities different from DCN 130. The remote server 470 can be a personal computer, a server, a router, a network PC, a peer device or other common network node, and/or any other remote media consumption or transmission device, and can include any or all of the elements described above relative to the computer. The logical connections depicted in FIG. 8 include a network 471, such as a local area network (LAN) or a wide area network (WAN), but can also include other networks/buses.

When used in a LAN networking environment, the computer is connected to the LAN 471 through a network interface or adapter. When used in a WAN networking environment, the computer can include a communications component, such as a modem, or other means for establishing communications over a WAN, such as the Internet. A communications component, such as a modem, which can be internal or external, can be connected to the system bus 421 through the user input interface at input 440 and/or other appropriate mechanism.

In a networked environment, program modules depicted relative to the computer, or portions thereof, can be stored in a remote memory storage device. It should be noted that the network connections shown and described are exemplary and other means of establishing a communications link between the computers can be used.

Additionally, it should be noted that as used in this application, terms such as “component,” “display,” “interface,” and other similar terms are intended to refer to a computing device, either hardware, a combination of hardware and software, software, or software in execution as applied to a computing device. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method for creation of a configuration file for a communication device in a communications network comprising a device configuration node, in response to detecting a stimulus to configure the communication device, the method comprising the steps of:
determining a communication device identity based on the stimulus;
retrieving, based on the communication device identity, a configuration file template comprising a data variable;
retrieving, based on the communication device identity, a data value corresponding to the data variable of the configuration file template;
assigning the retrieved data value to the corresponding data variable of the configuration file template; and
consolidating the configuration file template into a configuration file, wherein the step of retrieving the data value comprises traversing a hierarchical data structure comprising a plurality of data variables and wherein the data value is selected in accordance with an assignment rule.

2. The method according to claim 1, wherein the step of retrieving, based on the communication device identity, a configuration file template comprising a data variable, comprises selecting the configuration file template based on at least one of communication device characteristic, type of communication device contact with network, or type of stimulus.

3. The method according to claim 2, wherein the type of stimulus is any of a request received via a man-machine interface, a business support system or a network event trigger.

4. The method according to claim 1, wherein the step of determining further includes obtaining identities relating to a group of which the communication device, user or subscriber is a member.

5. The method according to claim 4, wherein the step of retrieving, based on the communication device identity, a configuration file template comprising a data variable is performed also based on the identities relating to the group of which the communication device, user or subscriber is a member.

6. The method according to claim 4, wherein the step of retrieving, based on the communication device identity, a data value for corresponding to the data variables of the configuration file template is performed also based on the identities relating to the group of which the communication device, user or subscriber is a member.

7. The method according to claim 1, wherein the step of transmitting comprises transmitting to a subscriber identity module of the communication device.

8. The method according to claim 1, wherein the step of retrieving, based on the communication device identity, a data value corresponding to the data variables of the configuration file template comprises retrieving the data value by lookup towards an external source.

9. The method according to claim 1, wherein the configuration file is a computer file of any of the types of plain text file, binary file, executable file or script file.

10. A device configuration node for creation of a configuration file for a communication device in a communications network comprising a processor and a memory storing instructions that when executed by the processor cause the device configuration node to, in response to detecting a stimulus to configure the communication device, perform operations comprising:
determining a communication device identity based on the stimulus;
retrieving, based on the communication device identity, a configuration file template comprising a data variable;
retrieving, based on the communication device identity, a data value corresponding to the data variable of the configuration file template;
assigning the retrieved data value to the corresponding data variable of the configuration file template with the corresponding data value; and
consolidating the configuration file template into a configuration file, wherein the retrieving the data value comprises traversing a hierarchical data structure comprising a plurality of data variables and wherein the data value is selected in accordance with an assignment rule.

11. The device configuration node according to claim 10, wherein the retrieving, based on the communication device identity, a configuration file template comprising a data variable, comprises selecting the configuration file template based on at least one of communication device characteristic, type of communication device contact with network, or type of stimulus.

12. The device configuration node according to claim 11, wherein the type of stimulus is any of a request received via a man-machine interface, a business support system or a network event trigger.

13. The device configuration node according to claim 10, wherein the determining further includes obtaining identities relating to a group of which the communication device, user or subscriber is a member.

14. The device configuration node according to claim 13, wherein the retrieving, based on the communication device identity, a configuration file template comprising a data variable is preformed also based on the identities relating to the group of which the communication device, user or subscriber is a member.

15. The device configuration node according to claim 13, wherein the retrieving, based on the communication device identity, a data value corresponding to the data variables of the configuration file template is performed also based on the additional identities relating to the group of which the communication device, user or subscriber is a member.

16. The device configuration node according to claim 10, wherein the transmitting comprises transmitting to a subscriber identity module of the communication device.

17. The device configuration node according to claim 10, wherein the retrieving, based on the communication device identity, a data value corresponding to the data variables of the configuration file template comprises retrieving the data value by lookup towards an external source.

18. The device configuration node according to claim 10, wherein the configuration file is a computer file of any of the types of plain text file, binary file, executable file or script file.
